(19) United States
(12) Patent Application Publication
(10) Pub. No.: US 2026/0274113 A1
(43) Pub. Date: Sep. 17, 2026

(54) BATTERY APPARATUS, METHOD FOR CONTROLLING BATTERY APPARATUS, AND VEHICLE

(71) Applicant: KABUSHIKI KAISHA TOSHIBA, Kawasaki-shi Kanagawa (JP)

(72) Inventors: Yasuhiro HARADA, Isehara Kanagawa (JP); Keigo HOSHINA, Yokohama Kanagawa (JP); Yoshiaki MURATA, Kawasaki Kanagawa (JP); Kento KANO, Tokyo (JP); Kakuya UEDA, Kawasaki Kanagawa (JP)

(73) Assignee: KABUSHIKI KAISHA TOSHIBA, Kawasaki-shi Kanagawa (JP)

(21) Appl. No.: 19/534,931

(22) Filed: Feb. 10, 2026

(30) Foreign Application Priority Data
Mar. 14, 2025 (JP) 2025-041734

(51) Int. Cl. B60L 58/27; B60L 7/10; B60L 58/26; H01M 10/44

(52) U.S. Cl. CPC B60L 58/27; B60L 7/10; B60L 58/26; H01M 10/443; B60L 2240/545; B60L 2240/549

(57) ABSTRACT

An apparatus according to one embodiment, includes a battery module that includes secondary batteries; a temperature detector that detects a temperature of at least one of the secondary batteries; a current detector that detects a charge/discharge current of the battery module; a cooler that cools the battery module; and a processor that periodically acquires values of detected temperature and current; compares a temperature value of the secondary battery with a threshold value; and stops the cooler and outputs a signal requesting the charge current of the battery module to a host control apparatus in a case where the battery module is discharged and the temperature value of the secondary battery becomes less than the threshold value.

### CROSS-REFERENCE TO RELATED APPLICATION

This application is based upon and claims the benefit of priority from Japanese Patent Application No. 2025-041734, filed Mar. 14, 2025; the entire contents of which are incorporated herein by reference.

### FIELD

Embodiments described herein relate generally to a battery apparatus, a method for controlling a battery apparatus, and a vehicle.

### BACKGROUND

In recent years, the performance of secondary batteries has been improved, and there are a wide variety of application fields such as portable electronic equipment, hybrid vehicles, electric vehicles, and power supplies for power storage. From these backgrounds, not only high input-output performance and high energy density but also a long life and a wide operating temperature range are indicated as performance required for the secondary battery. Further, along with an increase in power of power supplies for the intended uses, a battery module in which many unit cells are stacked is used. In particular, in recent years, a method of using a secondary battery capable of exhibiting stable performance regardless of the operation environment is also required.

In addition, the temperature of the secondary battery changes with charging and discharging of the secondary battery. For example, if operation is performed such that the temperature of the secondary battery is lowered in a low temperature environment, there is a possibility that the output performance of the secondary battery may be remarkably lowered.

### BRIEF DESCRIPTION OF DRAWINGS

FIG. 1 is a block diagram schematically illustrating a configuration of a battery apparatus according to an embodiment.

FIG. 2 is a block diagram schematically illustrating a configuration example of a vehicle on which the battery apparatus according to the embodiment is mounted.

FIG. 3 is a cross-sectional view schematically illustrating an example of the secondary battery included in the battery module illustrated in FIG. 1.

FIG. 4 is an enlarged cross-sectional view of a section A of the secondary battery illustrated in FIG. 3.

FIG. 5 is a flowchart for explaining an example of operations of the battery apparatus and the vehicle according to the embodiment.

FIG. 6 is a diagram schematically illustrating an example of effects of the battery apparatus and the vehicle according to the embodiment.

FIG. 7 is a diagram for explaining an example of a battery apparatus, a method for controlling a battery apparatus, and a vehicle according to a comparative example.

### DETAILED DESCRIPTION

A battery apparatus of an embodiment comprises a battery module that comprises a plurality of secondary batteries; a temperature detector that detects a temperature of at least one of the secondary batteries; a current detector that detects a charge/discharge current of the battery module; a cooler that cools the battery module; and a processor that periodically acquires values of detected temperature and charge/discharge current; compares a temperature value of the secondary battery with a threshold value; and stops the cooler and outputs a signal requesting the charge current of the battery module to a host control apparatus in a case where the battery module is discharged and the temperature value of the secondary battery becomes less than the threshold value.

Hereinafter, a battery apparatus, a method for controlling a battery apparatus, and a vehicle according to an embodiment will be described with reference to the drawings. In the following description, the same components are denoted by the same reference numerals, and the description thereof will be omitted.

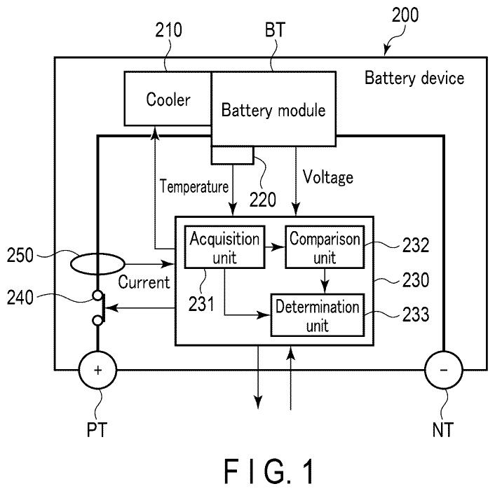

FIG. 1 is a block diagram schematically illustrating a configuration of a battery apparatus according to an embodiment.

A battery apparatus 200 of the present embodiment includes a battery module BT, a cooler 210, a temperature sensor (temperature detector) 220, a battery management circuit 230, a circuit breaker 240, a current sensor (current detector) 250, a positive electrode terminal PT, and a negative electrode terminal NT.

The battery module BT includes a plurality of secondary batteries 100 (illustrated in FIG. 3). The secondary battery 100 may be, for example, a lithium ion secondary battery. The secondary battery 100 also includes a nonaqueous electrolyte secondary battery including a nonaqueous electrolyte. The secondary batteries 100 are connected in series and (or) in parallel so as to realize a capacity, an output current, an energy density, and the like of the battery module BT necessary for equipment on which the battery apparatus 200 is mounted. A positive electrode of the battery module BT is electrically connected to the positive electrode terminal PT of the battery apparatus 200 by a main circuit on the high potential side. A negative electrode of the battery module BT is electrically connected to the negative electrode terminal NT of the battery apparatus 200 by a main circuit on the low potential side.

The secondary battery 100 may include a positive electrode, a negative electrode, and an electrolyte. The secondary battery 100 may further include a separator provided between the negative electrode and the positive electrode. The negative electrode, the positive electrode, and the separator can constitute an electrode group. The electrolyte may be held in the electrode group.

The secondary battery 100 can further include a container member that houses the electrode group and the electrolyte. The secondary battery 100 can further include a negative electrode terminal electrically connected to the negative electrode and a positive electrode terminal electrically connected to the positive electrode.

The secondary battery 100 may be, for example, a lithium secondary battery. The secondary battery 100 is, for example, a lithium ion secondary battery including a negative electrode containing a niobium-containing composite oxide, in which a basic skeleton of a crystal structure of the niobium-containing composite oxide is a Wadsley-Roth phase. The secondary battery 100 also includes a nonaqueous electrolyte secondary battery including a nonaqueous electrolyte. The configuration of the secondary battery 100 will be described in detail later with reference to the drawings.

Here, an example of thermal behavior of the secondary battery 100 included in the battery module BT will be described.

The secondary battery 100 is, for example, a lithium ion secondary battery in which an entropy change amount of a total battery reaction in a case where the secondary battery 100 is discharged at normal temperature and atmospheric pressure is endothermic (negative) at a predetermined depth of discharge or more. In addition, the secondary battery 100 included in the battery module BT includes an electrode active material (at least one of a positive electrode active material and a negative electrode active material) having a depth of discharge (DOD) region (range) where a relationship between an endothermic amount Qdis during discharging and an exothermic amount Qjex due to an internal resistance of the secondary battery 100 satisfies endothermic amount Qdis>exothermic amount Qjex in a case where the secondary battery 100 is discharged from a fully charged state at a predetermined discharge rate.

In the present embodiment, the secondary battery 100 is, for example, a lithium ion secondary battery in which the entropy change amount of the total battery reaction during discharging at normal temperature and atmospheric pressure is endothermic (negative) in a range of 30% or more with respect to the entire region of the depth of discharge. Further, the secondary battery 100 is desirably a lithium ion secondary battery in which the entropy change amount of the total battery reaction during discharging at normal temperature and atmospheric pressure is endothermic (negative) in a range of 50% or more with respect to the entire region of the depth of discharge. As described later, the exothermic amount (endothermic amount) of the secondary battery 100 due to the total battery reaction is a product of a temperature T_{cell} of the secondary battery 100 and an entropy change amount ΔS. In addition, a range of a predetermined proportion of the depth of discharge with respect to the entire region may be a case where one continuous range occupies a predetermined proportion with respect to the entire region, or may be a case where a sum of proportions of a plurality of discontinuous ranges with respect to the entire region occupies a predetermined proportion.

As described above, in a case where the discharge of the secondary battery 100 was continuously performed and the temperature of the secondary battery 100 was observed, the temperature of the secondary battery 100 had a characteristic of gradually decreasing. In particular, in a case where the discharge rate of the secondary battery 100 was low, the exothermic amount (=I²·R) (I: charge/discharge current value, R: battery internal resistance) due to the internal resistance of the secondary battery 100 became low, and thus, upon continuous discharge of the secondary battery 100 at a discharge rate (for example, about 0.2 C) equal to or less than a predetermined threshold value in a low temperature environment, the temperature of the secondary battery 100 remarkably decreased.

In addition, during charging of the secondary battery 100, heat is generated accompanying a change in crystal structure of the active material (active material of at least one of the positive electrode and the negative electrode) due to insertion/extraction of lithium ions. The exothermic amount Qchg accompanying the change in crystal structure of the electrode during charging is a sum of the exothermic (or endothermic) amount required for the change in crystal structure of the positive electrode active material and the exothermic (or endothermic) amount required for the change in crystal structure of the negative electrode active material. For example, in a case where the exothermic amount required for the change in crystal structure of the active material of the other electrode (e.g., the negative electrode) is clearly greater than the exothermic amount required for the change in crystal structure of the active material of one electrode (e.g., the positive electrode) of the secondary battery 100, the influence of the exothermic amount required for the change in crystal structure of the active material of the one electrode can be ignored and the exothermic amount required for the change in crystal structure of the active material of the other electrode can be treated as the exothermic amount Qchg.

The exothermic amount accompanying the change in crystal structure of the electrode active material of the secondary battery 100 can be confirmed by measuring the entropy change and calculating the amount of heat generated by the change in crystal structure of the active material due to an electrochemical reaction using the measurement result.

For example, the secondary batteries 100 adjusted to an arbitrary SOC were first kept in a constant temperature water bath at 40° C. for 21 hours, and then the water temperature was kept at 10° C., 20° C., 30° C., and 40° C. for 3 hours, respectively, and a change dV₀/dT in open-circuit voltage V₀ with respect to the temperatures of the secondary batteries 100 was measured. An electromotive force E_{emf} of the secondary battery 100 is approximated by the open-circuit voltage V₀, and the entropy change ΔS and an entropy heat generation Qs can be calculated by the following equations (1) and (2).

$${Q}_{s} = {T}_{cell} \cdot Δ S \cdot \frac{I}{F} \qquad ( 1 )$$

$$Δ S = - \frac{\partial Δ G}{\partial {T}_{cell}} = n \cdot F \cdot \frac{\partial {E}_{emf}}{\partial {T}_{cell}} \qquad ( 2 )$$

In the above equations, T_{cell} is the temperature of the secondary battery, I is the charge/discharge current which is positive during charging, n is the number of charges involved in the reaction, and F is the Faraday constant.

The cooler 210 cools the secondary battery 100 of the battery module BT. The cooler 210 may include, for example, a fan or a radiator, and can cool the secondary battery by supplying a gas or liquid refrigerant to the battery module BT. The cooler 210 may be capable of being adjusted in magnitude of the cooling function by adjusting an amount of the refrigerant to be discharged or a temperature of the refrigerant. Operation of the cooler 210 is controlled by a control signal from the battery management circuit 230.

The temperature sensor (temperature detector) 220 detects a temperature of at least one of the secondary batteries included in the battery module BT, and supplies a detected value to the battery management circuit 230. The temperature sensor 220 may include a plurality of sensor elements attached to the secondary batteries so as to detect the temperature of each of the secondary batteries. In addition, the temperature sensor 220 may include one or more sensor elements attached to an arbitrary secondary battery such as a secondary battery having the highest temperature or a secondary battery having the lowest temperature among the secondary batteries so as to detect the temperature of the arbitrary secondary battery.

The current sensor (current detector) 250 is attached to, for example, a main circuit connecting the positive electrode of the battery module BT and the positive electrode terminal PT of the battery apparatus 200, and detects a charge/discharge current (a value of a main circuit current flowing through the main circuit) of the battery module BT.

The circuit breaker 240 can switch an electrical connection state of the main circuit on the high potential side. For example, the circuit breaker 240 may be configured to connect or disconnect the main circuit on the high potential side according to an electric signal from the battery management circuit 230, or may be configured to mechanically connect or disconnect the main circuit on the high potential side. In the present embodiment, the circuit breaker 240 is, for example, an electromagnetic contactor that switches according to the signal of the battery management circuit 230.

The battery management circuit 230 includes, for example, an arithmetic circuit including at least one processor such as a micro processing unit (MPU) or a central processing unit (CPU) and a memory in which a program to be executed by the processor is stored, and can realize various functions described below by software or by a combination of software and hardware.

The battery management circuit 230 includes an acquisition unit 231, a comparison unit 232, and a determination unit 233. The acquisition unit 231 acquires voltage of each of the secondary batteries 100 included in the battery module BT. For example, the acquisition unit 231 may acquire the positive electrode voltage and the negative electrode voltage of each of the secondary batteries 100 and calculate the voltage of each of the secondary batteries 100. In addition, the acquisition unit 231 acquires the temperature value of each of the secondary batteries 100 from the temperature sensor 220, and acquires the values of the charge current and the discharge current (main circuit current values) of the battery module BT from the current sensor 250. The acquisition unit 231 may calculate values of SOC (State of charge), SOH (State of health), DOD, and the like of each of the secondary batteries (or the battery module BT) by using the acquired values of the voltage, current, and temperature.

The battery management circuit 230 has a function of communicating with the host control apparatus, and periodically outputs the values of the voltage and temperature of each of the secondary batteries 100 acquired by the acquisition unit 231 and the main circuit current value to the host control apparatus. In addition, the battery management circuit 230 periodically outputs the values of the SOC, SOH, and DOD calculated by the acquisition unit 231 to the host control apparatus. In addition, the battery management circuit 230 can control the cooler 210 and the circuit breaker 240 according to a control signal acquired from the host control apparatus.

The comparison unit 232 outputs a result of comparison between the value acquired and calculated by the acquisition unit 231 and the corresponding threshold value. For example, the comparison unit 232 outputs a result of comparing the temperature value of the secondary battery 100 with the corresponding threshold value (whether the temperature value is equal to or more than the threshold value or less than the threshold value) to the determination unit 233.

For example, the determination unit 233 determines whether or not the battery module BT is discharging by using the main circuit current value supplied from the acquisition unit 231, and stops cooling by the cooler 210 and transmits a signal requesting the charge current to the host control apparatus in a case where the temperature of the secondary battery 100 is lower than the threshold value during discharging of the battery module BT (for example, assuming that the main circuit current value during charging is positive, the main circuit current value is negative). Upon supply of the charge current from the host equipment, the battery module BT is charged with the equipment current supplied from the host equipment in a state where the cooler 210 is stopped, and the secondary battery 100 can be warmed using heat generation of the secondary battery 100.

The battery management circuit 230 periodically acquires and monitors the temperature value of the secondary battery 100 by the acquisition unit 231 even while the battery module BT is charged with the charge current supplied from the host equipment, and in a case where the temperature value of the secondary battery 100 becomes equal to or more than the threshold value, the determination unit 233 starts cooling by the cooler 210 and requests the host control apparatus to stop the charge current. If the supply of the charge current from the host equipment is stopped, the charging of the battery module BT is stopped and the battery module BT can be discharged.

For example, the comparison unit 232 may compare minimum values or maximum values of the temperatures of the secondary batteries 100 with the corresponding threshold value, or may compare an average value or median value of the temperatures of the secondary batteries 100 with the corresponding threshold value. In addition, the battery management circuit 230 may compare the temperature of a specific secondary battery 100 whose temperature is likely to decrease, among the secondary batteries 100, with the corresponding threshold value. Some of the above functions of the battery management circuit 230 may be possessed by the host control apparatus, and some of the functions of the host control apparatus may be possessed by the battery management circuit 230.

Further, a plurality of threshold values related to the temperature of the secondary battery 100 may be set. For example, the comparison unit 232 may compare the minimum values of the temperatures of the secondary batteries 100 with a first threshold value, control operation of the cooler 210 according to a result of comparing the average value of the temperatures of the secondary batteries 100 with a second threshold value, and request the charge current to charge the secondary batteries 100. In addition, the comparison unit 232 may set the corresponding temperature threshold value for each of several specific secondary batteries 100 among the secondary batteries 100. In a case where a plurality of temperature threshold values are set for the secondary batteries 100, the determination unit 233 may stop the cooler 210 and request the charge current to the host control apparatus in response to the temperature value of any one of the secondary batteries 100 being less than the threshold value, or may stop the cooler 210 and request the charge current from the host control apparatus, in response to the temperature values of the secondary batteries 100 being less than the threshold value.

The threshold value related to the temperature of the secondary battery 100 may be, for example, a lower limit value of a temperature range in which the performance of the secondary battery 100 can be exhibited, or may be a value exceeding the lower limit value. For example, even if the active material of the electrode of the secondary battery 100 falls outside the region of the depth of discharge (or SOC) where the endothermic amount Qen>the exothermic amount Qex, in a case where the temperature of the secondary battery 100 is lower than the threshold value, the battery management circuit 230 stops the cooler 210 so that the temperature of the secondary battery 100 falls within an appropriate range, and the battery module BT is brought into a state of being charged with the current supplied from the host apparatus, thereby making it possible to avoid performance degradation due to a decrease in temperature of the secondary battery 100.

It is also conceivable that, even if the active material of the electrode of the secondary battery 100 has a depth of discharge (or SOC) such that the endothermic amount Qen>the exothermic amount Qjex, if the temperature of the secondary battery 100 is equal to or higher than the threshold value, the secondary battery 100 can exhibit sufficient performance. As described above, in the battery apparatus 200 according to the present embodiment, the battery management circuit 230 brings the secondary battery 100 into a state where the secondary battery 100 can be charged with the current supplied from the host apparatus in response to the temperature of the secondary battery 100 decreasing to lower than the threshold value regardless of the SOC or the discharge rate of the secondary battery, thereby making it possible to avoid a decrease in performance of the secondary battery 100.

That is, according to the battery apparatus 200 including the host battery management circuit 230, the secondary battery 100 is maintained at an appropriate temperature for exhibiting performance, and it is possible to suppress performance degradation of the secondary battery 100 and the battery module BT.

In the battery apparatus 200 of the above embodiment, the determination unit 233 compares the temperature value of the secondary battery 100 with the threshold value to determine whether or not to perform charging with the charge current supplied from the host equipment, but the present invention is not limited thereto. For example, in a case where a period of time during which the battery module BT is continuously discharged at a discharge rate equal to or lower than the threshold value exceeds the threshold value, the determination unit 233 may stop the cooler 210 and request the charge current from the host control apparatus.

In a case where the battery module BT is discharging and the active material of the electrode of the secondary battery 100 is in the DOD region (for example, the range is 30% or more with respect to the entire DOD region, and desirably, the range is 50% or more with respect to the entire DOD region) where the endothermic amount Qdis>the exothermic amount Qjex, the battery management circuit 230 may stop the cooler 210 and request the charge current from the host control apparatus.

Furthermore, the battery management circuit 230 may have a function of adjusting the temperature of the secondary battery 100 by controlling the operation of the cooler 210 and controlling a charge amount and a discharge amount of the battery module BT according to the temperature of the secondary battery 100 included in the battery module BT.

For example, the battery management circuit 230 can gradually lower the temperature of the secondary battery 100 by setting the discharge amount (target SOC) so that the electrode active material of the secondary battery 100 has a depth of discharge satisfying the endothermic amount Qdis>the exothermic amount Qjex, and can suppress the temperature decrease of the secondary battery 100 by setting the charge amount (target SOC) so that the active material of the secondary battery 100 satisfies the endothermic amount Qdis<the exothermic amount Qjex (outside the depth of discharge region satisfying the endothermic amount Qdis>the exothermic amount Qjex). Using this, the battery management circuit 230 may set a schedule of target values of the SOC and the DOD of the secondary battery 100 according to, for example, the temperature of the environment in which the battery apparatus 200 is used, the weather forecast (predicted air temperature), the past use method, and the like, thereby systematically adjusting the temperature of the secondary battery 100 so as to correspond to the use method of the battery apparatus 200.

Next, a configuration example in which the battery apparatus 200 of the above embodiment is mounted on a vehicle will be described.

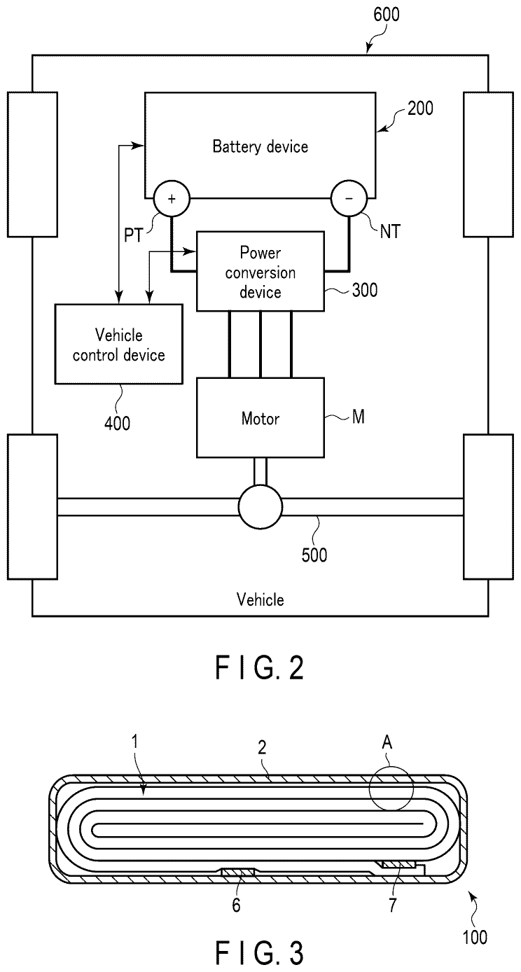

FIG. 2 is a block diagram schematically illustrating a configuration example of a vehicle on which the battery apparatus according to the embodiment is mounted.

A vehicle 600 includes a battery apparatus 200, a power conversion apparatus 300, a vehicle control apparatus 400, a motor M, and an axle 500. Note that the vehicle 600 is host equipment of the battery apparatus 200, and the vehicle control apparatus 400 is a host control apparatus of the battery apparatus 200.

The power conversion apparatus 300 can convert DC power supplied from the battery apparatus 200 into AC power and output the AC power to the motor M, and can convert AC power supplied from the motor M into DC power and output the DC power to the battery apparatus 200. The power conversion apparatus 300 includes, for example, a bidirectional three-phase AC inverter and an inverter control circuit. A DC main circuit on the positive side of the three-phase AC inverter is electrically connected to a positive electrode PT of the battery apparatus 200, and a DC main circuit on the negative side is electrically connected to a negative electrode NT of the battery apparatus 200. An AC output end of each phase of the three-phase AC inverter is electrically connected to an AC line of each phase between the three-phase AC inverter and the motor M. The inverter control circuit controls a switching operation of the three-phase AC inverter in accordance with an output command supplied from the vehicle control apparatus 400.

The motor M includes a stator that forms a magnetic field inside the motor M by AC power supplied from the power conversion apparatus 300, and a rotor that rotates by the magnetic field formed by the stator. Power generated by the rotation of the rotor is transmitted to the axle 500. Upon rotation of the axle 500, wheels of the vehicle 600 can be rotated to cause the vehicle 600 to travel.

In addition, the motor M functions as a generator that generates power upon rotation of the rotor by rotational power of the axle 500, and can supply regenerative power (AC) generated by the traveling of the vehicle 600 to the power conversion apparatus 300.

The vehicle control apparatus 400 is a host control apparatus of the battery apparatus 200, and includes, for example, an arithmetic circuit including at least one processor such as an MPU or a CPU and a memory in which a program to be executed by the processor is stored. The vehicle control apparatus 400 performs control so that the configurations included in the vehicle 600 operate in cooperation by software or a combination of software and hardware.

In a case where receiving a request for a charge current (regenerative current) from the battery management circuit 230 of the battery apparatus 200, the vehicle control apparatus 400 supplies an output command to the power conversion apparatus 300 to output the regenerative current, and charges the battery module BT of the battery apparatus 200 with the regenerative current.

According to the vehicle 600 of the present embodiment, in a case where the temperature of the secondary battery 100 is lower than the threshold value, the battery management circuit 230 stops the cooler 210 so that the temperature of the secondary battery 100 falls within an appropriate range, and charges the battery module BT by the regenerative current supplied from the power conversion apparatus 300, thereby making it possible to warm the secondary battery 100 and avoid performance degradation due to a decrease in temperature of the secondary battery 100.

In the vehicle 600, the vehicle control apparatus 400 may have some of the functions of the battery management circuit 230. For example, the vehicle control apparatus 400 may have the functions of the comparison unit 232 and the determination unit 233 of the battery management circuit 230, and the vehicle control apparatus 400 may have the function of the acquisition unit 231 that calculates the SOC, SOH, and DOD. Even in this case, the same effect as that of the vehicle 600 can be obtained.

### (Secondary Battery)

Next, an example of the configuration of the secondary battery 100 included in the battery module BT of the battery apparatus 200 will be described in detail.

FIG. 3 is a cross-sectional view schematically illustrating an example of the secondary battery included in the battery module illustrated in FIG. 1.

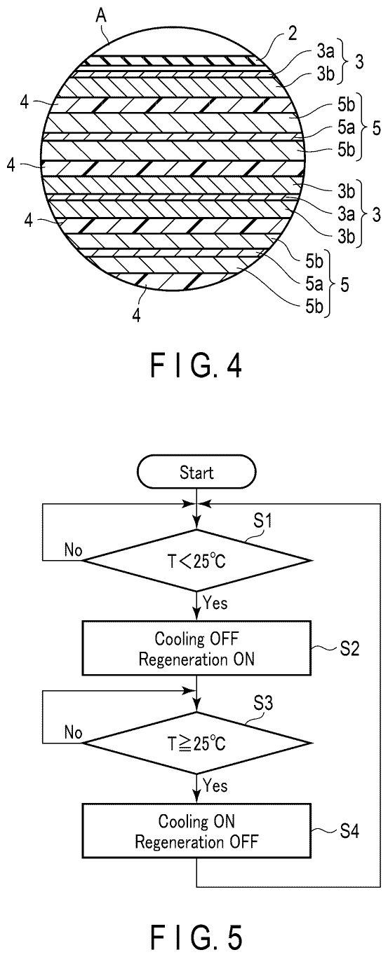

FIG. 4 is an enlarged cross-sectional view of a section A of the secondary battery illustrated in FIG. 3.

A secondary battery 100 as illustrated in FIGS. 3 and 4 includes a bag-shaped container member 2 as illustrated in FIGS. 3 and 4, an electrode group 1 as illustrated in FIG. 4, and an electrolyte which is not illustrated. The electrode group 1 and the electrolyte are housed in the bag-shaped container member 2. The electrolyte (not illustrated) is held in the electrode group 1.

The bag-shaped container member 2 is made of a laminate film including two resin layers and a metal layer sandwiched between the resin layers.

As illustrated in FIG. 3, the electrode group 1 is a wound electrode group in a flat form. The wound electrode group 1 in a flat form includes a negative electrode 3, a separator 4, and a positive electrode 5, as illustrated in FIG. 4. The separator 4 is sandwiched between the negative electrode 3 and the positive electrode 5.

The negative electrode 3 includes a negative electrode current collector 3a and a negative electrode active material-containing layer 3b. At a portion of the negative electrode 3 positioned outermost among the wound electrode group 1, the negative electrode active material-containing layer 3b is formed only on an inner surface of the negative electrode current collector 3a, as illustrated in FIG. 3. At the other portions of the negative electrode 3, the negative electrode active material-containing layers 3b are formed on both sides of the negative electrode current collector 3a.

The positive electrode 5 includes a positive electrode current collector 5a and positive electrode active material-containing layers 5b formed on both sides of the positive electrode current collector 5a.

As illustrated in FIG. 3, a negative electrode terminal 6 and a positive electrode terminal 7 are positioned in vicinity of an outer peripheral end of the wound electrode group 1. The negative electrode terminal 6 is connected to a portion of the negative electrode current collector 3a positioned outermost. The positive electrode terminal 7 is connected to a portion of the positive electrode current collector 5a positioned outermost. The negative electrode terminal 6 and the positive electrode terminal 7 extend outside from an opening of the bag-shaped container member 2. A thermoplastic resin layer is provided on an inner surface of the bag-shaped container member 2, and the opening is closed by heat-sealing the resin layer.

Hereinafter, examples of the negative electrode, positive electrode, electrolyte, separator, container member, negative electrode terminal, and positive electrode terminal of the secondary battery will be described.

### 1) Negative Electrode

The negative electrode may include a negative electrode current collector and a negative electrode active material-containing layer. The negative electrode active material-containing layer can be formed on one side or both sides of the negative electrode current collector. The negative electrode active material-containing layer can include a negative electrode active material, and optionally a conductive agent and a binder.

Examples of the negative electrode active material include lithium titanate having a ramsdellite structure (e.g., Li_{2+y}Ti₃O₇, 0≤y≤3), lithium titanate having a spinel structure (e. g., Li₄₊ₓTi₅O₁₂, 0≤x≤3), titanium dioxide (TiO₂), anatase titanium dioxide, rutile titanium dioxide, niobium pentoxide (Nb₂O₅), hollandite titanium composite oxide, orthorhombic titanium composite oxide, and niobium titanium-containing oxide.

A basic skeleton of a crystal structure of the niobium titanium-containing oxide is desirably a Wadsley-Roth phase. Examples of the niobium titanium-containing oxide in which the basic skeleton of the crystal structure is a Wadsley-Roth phase include those including at least one crystal phase selected from the group consisting of an Nb₂TiO₇ phase, an Nb₁₀Ti₂O₂₉ phase, an Nb₁₄TiO₃₇ phase, and an Nb₂₄TiO₆₂ phase. The Nb₂TiO₇ phase, the Nb₁₀Ti₂O₂₉ phase, the Nb₁₄TiO₃₇ phase, and the Nb₂₄TiO₆₂ phase have, for example, a monoclinic crystal structure. The Nb₁₀Ti₂O₂₉ phase can also have an orthorhombic crystal structure.

An example of the monoclinic niobium titanium-containing oxide is a compound represented by LiₓTi_{1-y}M1_{y}Nb_{2-z}M2_{z}O_{7+δ}. Here, M1 is at least one selected from the group consisting of Zr, Si, and Sn. M2 is at least one selected from the group consisting of V, Ta, and Bi. The respective subscripts in the composition formula are as follows: 0≤x≤5, 0≤y<1, 0≤z<2, and −0.3≤δ≤0.3. A specific example of the monoclinic niobium titanium-containing oxide is LiₓNb₂TiO₇ (0≤x≤5).

Another example of the monoclinic niobium titanium-containing oxide is a compound represented by LiₓTi_{1-y}M3_{y+z}Nb_{2-z}O_{7-δ}. Here, M3 is at least one selected from Mg, Fe, Ni, Co, W, Ta, and Mo. The respective subscripts in the composition formula are as follows: 0≤x≤5, 0≤y<1, 0≤z<2, and −0.3≤δ≤0.3.

The conductive agent is blended to enhance current collection performance and to suppress contact resistance between the active material and the current collector. Examples of the conductive agent include carbonaceous materials such as vapor grown carbon fiber (VGCF), carbon blacks such as acetylene black, graphite, carbon nanotubes, and carbon nanofibers. One of these may be used as the conductive agent, or two or more thereof may be used in combination as the conductive agent. Alternatively, instead of using the conductive agent, a carbon coat or an electronically conductive inorganic material coat may be applied to the surfaces of the active material particles.

The binder is blended to fill gaps among the dispersed active material and also to bind the active material with the current collector. Examples of the binder include polytetrafluoroethylene (PTFE), polyvinylidene fluoride (PVdF), fluorine rubber, styrene-butadiene rubber, polyacrylic acid compounds, imide compounds, carboxymethyl cellulose (CMC), and salts of CMC. One of these may be used as the binder, or alternatively, two or more thereof may be used in combination as the binder.

Blending proportions of the active material, conductive agent and binder in the active material-containing layer can be appropriately changed according to the intended use of the electrode. For example, in a case of using the electrode as a negative electrode of a secondary battery, the active material (negative electrode active material), conductive agent and binder are preferably blended in proportions of 68 mass % or more and 96 mass % or less, 2 mass % or more and 30 mass % or less, and 2 mass % or more and 30 mass % or less, respectively.

There may be used for the current collector, a material which is electrochemically stable at a potential at which lithium (Li) is inserted into and extracted from the active material. For example, in a case where the active material is used as the negative electrode active material, the current collector is preferably made of copper, nickel, stainless steel, aluminum, or an aluminum alloy including one or more elements selected from the group consisting of Mg, Ti, Zn, Mn, Fe, Cu, and Si. A thickness of the current collector is preferably 5 μm or more and 20 μm or less. The current collector having such a thickness can achieve a balance between strength and weight reduction of the electrode.

The current collector can include a portion where no negative electrode active material-containing layer is formed on a surface thereof. This portion can serve as a negative electrode collector tab.

The negative electrode can be fabricated, for example, by the following method. First, a slurry is prepared by suspending an active material, a conductive agent and a binder in a solvent. This slurry is applied to one side or both sides of the current collector. Then, the applied slurry is dried to obtain a stack of an active material-containing layer and the current collector. Then, the stack is subjected to pressing. The negative electrode is fabricated in this manner.

### 2) Positive Electrode

The positive electrode can include a positive electrode current collector and a positive electrode active material-containing layer. The positive electrode active material-containing layer may be formed on one side or both sides of the positive electrode current collector. The positive electrode active material-containing layer can include a positive electrode active material, and optionally a conductive agent and a binder.

As the positive electrode active material, for example, an oxide or a sulfide can be used. The positive electrode may include one type of compound singly as the positive electrode active material, or, alternatively, may include two or more types of compounds in combination. Examples of the oxide and sulfide include compounds capable of allowing Li or Li ions to be inserted and extracted.

Examples of such compounds include manganese dioxide (MnO₂), iron oxides, copper oxides, nickel oxides, lithium-manganese composite oxides (e.g., LiₓMn₂O₄ or LiₓMnO₂; 0<x≤1), lithium-nickel composite oxides (e. g., LiₓNiO₂; 0<x≤1), lithium-cobalt composite oxides (e.g., LiₓCoO₂; 0<x≤1), lithium-nickel-cobalt composite oxides (e.g., LiₓNi_{1-y}CO_{y}O₂; 0<x≤1, 0<y<1), lithium-manganese-cobalt composite oxides (e.g., LiₓMn_{y}CO_{1-y}O₂; 0<x≤1, 0<y≤1), lithium-manganese-nickel composite oxides having a spinel structure (e.g., LiₓMn_{2-y}Ni_{y}O₄; 0<x≤1, 0<y<2), lithium-phosphorus oxides having an olivine structure (e. g., LiₓFePO₄; 0<X≤1, LiₓFe_{1-y}Mn_{y}PO₄; 0<x≤1, 0<y≤1, and LiₓCoPO₄; 0<x≤1), iron sulfate (Fe₂(SO₄)₃), vanadium oxides (e.g., V₂O₅), and lithium-nickel-cobalt-manganese composite oxide (LiₓNi_{1-y-z}CO_{y}Mn_{z}O₂; 0<x≤1, 0<y<1, 0<z<1, y+z<1).

The binder is blended to fill gaps among the dispersed positive electrode active material and also to bind the positive electrode active material with the positive electrode current collector. Examples of the binder include polytetrafluoro ethylene (PTFE), polyvinylidene fluoride (PVdF), fluororubber, polyacrylic acid compounds, imide compounds, carboxymethyl cellulose (CMC), and salts of CMC. One of these may be used as the binder, or alternatively, two or more thereof may be used in combination as the binder.

The conductive agent is blended to improve current collection performance and to suppress contact resistance between the positive electrode active material and the positive electrode current collector. Examples of the conductive agent include carbonaceous materials such as vapor grown carbon fiber (VGCF), carbon black such as acetylene black, and graphite. One of these may be used as the conductive agent, or two or more thereof may be used in combination as the conductive agent. The conductive agent may not be used.

In the positive electrode active material-containing layer, the positive electrode active material and the binder are preferably blended in proportions of 80 mass % or more and 98 mass % or less, and 2 mass % or more and 20 mass % or less, respectively.

In a case where the conductive agent is added, the positive electrode active material, the binder, and the conductive agent are preferably blended in proportions of 77 mass % or more and 95 mass % or less, 2 mass % or more and 20 mass % or less, and 3 mass % or more and 15 mass or less, respectively.

The positive electrode current collector is preferably an aluminum foil, or an aluminum alloy foil including one or more selected from the group consisting of Mg, Ti, Zn, Ni, Cr, Mn, Fe, Cu, and Si.

A thickness of the aluminum foil or aluminum alloy foil is preferably 5 μm or more and 20 μm or less, and more preferably 15 μm or less. A purity of the aluminum foil is preferably 99 mass % or more. Contents of transition metals such as iron, copper, nickel, and chromium included in the aluminum foil or aluminum alloy foil are preferably 1 mass % or less.

The positive electrode current collector may include a portion where the positive electrode active material-containing layer is not formed, on a surface thereof. This portion can serve as a positive electrode collector tab.

### 3) Electrolyte

As the electrolyte, for example, a liquid nonaqueous electrolyte or gel nonaqueous electrolyte can be used. The liquid nonaqueous electrolyte is prepared by dissolving an electrolyte salt as a solute in an organic solvent. A concentration of the electrolyte salt is preferably 0.5 mol/L or more and 2.5 mol/L or less.

Examples of the electrolyte salt include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and lithium bistrifluoromethylsulfonylimide (LiN(CF₃SO₂)₂), and mixtures thereof.

Examples of the organic solvent include cyclic carbonates such as propylene carbonate (PC), ethylene carbonate (EC), and vinylene carbonate (VC); linear carbonates such as diethyl carbonate (DEC), dimethyl carbonate (DMC), and methyl ethyl carbonate (MEC); cyclic ethers such as tetrahydrofuran (THF), 2-methyl tetrahydrofuran (2-MeTHF), and dioxolane (DOX); linear ethers such as dimethoxy ethane (DME) and diethoxy ethane (DEE); γ-butyrolactone (GBL), acetonitrile (AN), and sulfolane (SL). These organic solvents may be used singly or as a mixed solvent.

The gel nonaqueous electrolyte is prepared by obtaining a composite of a liquid nonaqueous electrolyte and a polymeric material. Alternatively, other than the liquid nonaqueous electrolyte and gel nonaqueous electrolyte, an ambient temperature molten salt (ionic melt) containing lithium ions, a polymeric solid electrolyte, an inorganic solid electrolyte, or the like may be used as the nonaqueous electrolyte.

### 4) Separator

The separator may be made of, for example, a porous film or synthetic resin nonwoven fabric including polyethylene (PE), polypropylene (PP), cellulose, or polyvinylidene fluoride (PVdF). In view of safety, a porous film made of polyethylene or polypropylene is preferred. This is because, at a certain temperature, such a porous film melts and can shut off current.

### 5) Container Member

As the container member, for example, a container made of a laminate film or a container made of a metal may be used.

A thickness of the laminate film is, for example, 0.5 mm or less, and preferably 0.2 mm or less.

As the laminate film, used is a multilayer film including a plurality of resin layers and a metal layer sandwiched between the respective resin layers. The resin layer may include, for example, a polymeric material such as polypropylene (PP), polyethylene (PE), nylon, or polyethylene terephthalate (PET). The metal layer is preferably made of an aluminum foil or an aluminum alloy foil, in order to reduce weight. The laminate film may be formed into a shape of the container member, by heat-sealing.

A wall thickness of the metal container is, for example, 1 mm or less, more preferably 0.5 mm or less, and further preferably 0.2 mm or less.

The metal container is made, for example, of aluminum or an aluminum alloy. The aluminum alloy preferably includes elements such as magnesium, zinc, and silicon. In a case where the aluminum alloy includes a transition metal such as iron, copper, nickel, or chromium, a content thereof is preferably 100 ppm by mass or less.

The shape of the container member is not particularly limited. The shape of the container member may be, for example, flat (thin), prismatic, cylindrical, coin-shaped, or button-shaped. The container member may be appropriately selected depending on the battery dimensions and the intended use of the battery.

### 6) Negative Electrode Terminal

The negative electrode terminal can be formed of a material that is electrochemically stable at the Li insertion/extraction potential of the negative electrode active material described above and has conductivity. Specific examples of the material for the negative electrode terminal include copper, nickel, stainless steel, and aluminum, and aluminum alloys including at least one selected from the group consisting of Mg, Ti, Zn, Mn, Fe, Cu, and Si. Aluminum or an aluminum alloy is preferably used as the material for the negative electrode terminal. The negative electrode terminal is preferably made of the same material as the negative electrode current collector, in order to reduce contact resistance between the negative electrode terminal and the negative electrode current collector.

### 7) Positive Electrode Terminal

The positive electrode terminal can be formed of a material that is electrically stable in a potential range of 3 V or more and 4.5 V or less (vs. Li/Lit) relative to the oxidation-reduction potential of lithium, and having electrical conductivity. Examples of the material for the positive electrode terminal include aluminum and aluminum alloys including at least one selected from the group consisting of Mg, Ti, Zn, Mn, Fe, Cu, and Si. The positive electrode terminal is preferably formed of the same material as the positive electrode current collector, in order to reduce contact resistance between the positive electrode terminal and the positive electrode current collector.

### (Operation)

Next, an example of operations of the battery management circuit 230 and the vehicle control apparatus 400 in the vehicle 600 on which the battery apparatus 200 is mounted will be described.

FIG. 5 is a flowchart for explaining an example of operations of the battery apparatus and the vehicle according to the embodiment.

Here, an example of an operation while the vehicle 600 is traveling (power-running) by discharge power of the battery apparatus 200 will be described. Note that the temperature of the secondary battery 100 is equal to or higher than the threshold value at the time when the charging of the battery module BT is completed and the vehicle starts traveling, and the battery module BT is being cooled by the cooler 210.

The acquisition unit 231 periodically acquires the temperature values of the secondary batteries 100 included in the battery module BT, and supplies the acquired temperature values to the comparison unit 232. The comparison unit 232 outputs a result of comparing the temperature value of the one or more secondary batteries 100 supplied from the acquisition unit 231 with a threshold value (for example, 25° C.) to the determination unit 233, and the determination unit 233 determines whether or not the temperature value of the secondary battery 100 is less than the threshold value (step S1). Note that a cycle in which the acquisition unit 231 acquires the temperature value may be the same as or different from a cycle in which the comparison unit 232 compares the temperature value with the threshold value (or a cycle determined by the determination unit 233). The comparison unit 232 may compare the temperature value with the threshold value at least every sufficient period in which the temperature of the secondary battery 100 changes.

The acquisition unit 231, comparison unit 232, and determination unit 233 of the battery management circuit 230 repeat step S1 while the temperature of the secondary battery 100 is equal to or higher than the threshold value (step S1, No).

In a case where the temperature of the secondary battery 100 is lower than the threshold value (step S1, Yes), the determination unit 233 stops the cooling of the battery module BT by the cooler 210, and transmits a signal requesting a regenerative current (charge current) to the vehicle control apparatus 400 which is a host control apparatus. After transmitting the request for the charge current, the battery management circuit 230 periodically performs acquisition of the value of the temperature of the secondary battery 100 by the acquisition unit 231, comparison of the temperature value with the threshold value by the comparison unit 232, and determination as to whether the temperature value is less than the threshold value by the determination unit 233, and continues monitoring the temperature of the secondary battery 100.

Upon reception of a signal requesting a regenerative current (charge current) from the battery management circuit 230, the vehicle control apparatus 400 transmits an output command to the power conversion apparatus 300 to output the regenerative current (step S2).

The power conversion apparatus 300 controls operation of a switch of the inverter based on the output command supplied from the vehicle control apparatus 400, converts AC power generated by the motor M into DC power, and supplies a regenerative current (DC current) to the battery apparatus 200. The cooling of the battery module BT of the battery apparatus 200 by the cooler 210 is stopped, and the secondary battery 100 is charged with the regenerative current, thereby generating heat accompanying a change in crystal structure of the electrode due to insertion/extraction of lithium ions, and warming the secondary battery 100. The power conversion apparatus 300 and the motor M perform a regenerative operation to convert kinetic energy into electric energy, and the vehicle 600 decelerates by regenerative brake to perform a coasting operation.

While the battery module BT is being charged with the regenerative current, the battery management circuit 230 periodically performs acquisition of the value of the temperature of the secondary battery 100 by the acquisition unit 231, comparison of the temperature value with the threshold value by the comparison unit 232, and determination as to whether the temperature value is less than the threshold value by the determination unit 233 (step S3). The battery management circuit 230 repeats step S3 while the temperature of the secondary battery 100 is lower than the threshold value (step S3, No).

In a case where the temperature of the secondary battery 100 is equal to or higher than the threshold value (step S3, Yes), the determination unit 233 starts the cooling of the battery module BT by the cooler 210, and transmits a signal requesting the vehicle control apparatus 400 to stop the regenerative current (charge current) (step S4). After step S4, the battery management circuit 230 returns to step S1 and performs the above-described operation.

Note that the threshold value used by the comparison unit 232 in step S2 and the threshold value used by the comparison unit 232 in step S3 can be different values. For example, the first threshold value compared with the temperature value of the secondary battery 100 by the comparison unit 232 in step S1 may be a value smaller than the second threshold value compared with the temperature value of the secondary battery 100 by the comparison unit 232 in step S3. By cooling and discharging the secondary battery 100 after warming the secondary battery 100 to the second threshold value exceeding the first threshold value in step S2, the control of the battery apparatus 200 is not frequently switched near the threshold value.

Upon reception of a signal to stop the regenerative current from the battery management circuit 230, the vehicle control apparatus 400 stops the regenerative current and transmits an output command to the power conversion apparatus 300 to drive the motor M according to depressing force on an accelerator pedal of the vehicle 600 or the like. The power conversion apparatus 300 performs a switching operation of the inverter based on the output command supplied from the vehicle control apparatus 400, converts the discharge power of the battery apparatus 200 into AC power, and supplies the AC power to the motor M. The motor M is driven by the AC power supplied from the power conversion apparatus 300, and the rotational power of the motor M is transmitted to the axle 500 so that the vehicle 600 travels.

In a case where the vehicle control apparatus 400 has a part of the function of the battery management circuit 230, the battery management circuit 230 may periodically transmit the temperature values of the secondary batteries 100 to the vehicle control apparatus 400, and the vehicle control apparatus 400 may perform the operations of steps S1 to S4. In this case, the vehicle control apparatus 400 transmits a command to stop the cooling by the cooler 210 to the battery management circuit 230 in step S2, and transmits a command to start the cooling by the cooler 210 to the battery management circuit 230 in step S4.

### (Effect)

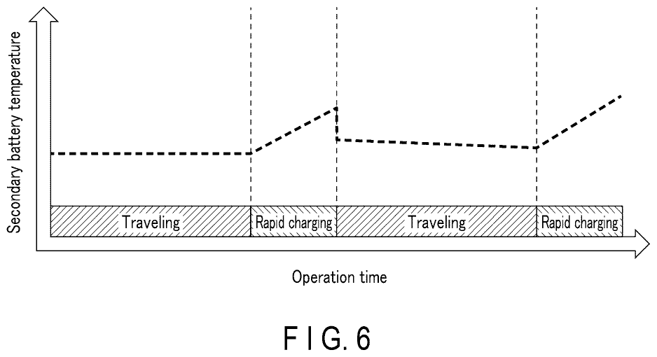

Next, effects of the battery apparatus 200 and the vehicle 600 having the above configurations will be described. FIG. 6 is a diagram schematically illustrating an example of effects of the battery apparatus and the vehicle according to the embodiment.

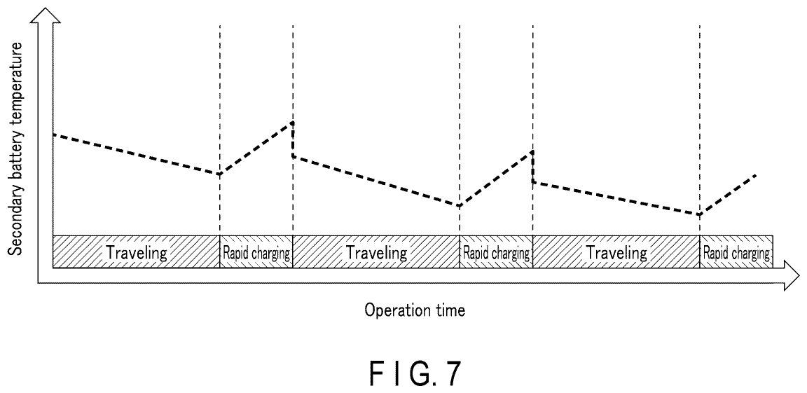

FIG. 7 is a diagram for explaining an example of a battery apparatus and a vehicle according to a comparative example.

The battery apparatus and the vehicle of the comparative example are different from the battery apparatus 200 and the vehicle 600 of the above-described embodiment in that the secondary battery is not warmed by stopping the cooler and charging the battery module with the regenerative current even in a case where the temperature of the secondary battery becomes lower than the threshold value during traveling of the vehicle (during discharging of the battery module), and are the same as those of the above-described embodiment in other respects.

FIG. 7 schematically illustrates an example of a temperature change of the secondary battery 100 while the vehicle on which the battery apparatus of the comparative example is mounted is traveling (power-running).

As illustrated in FIG. 7, in a case where the battery module is not charged with the regenerative current during traveling of the vehicle, the temperature of the secondary battery gradually decreases due to discharge. Therefore, even in a case where rapid charging is performed, there is a possibility that the temperature of the secondary battery may gradually decrease due to continuous operation. Upon gradual decrease of the temperature of the secondary battery, the output performance of the secondary battery remarkably decreases, and it becomes difficult for the battery apparatus and the vehicle to exhibit stable performance.

FIG. 6 schematically illustrates an example of a temperature change of the secondary battery 100 while the vehicle 600 on which the battery apparatus 200 of the above-described embodiment is mounted is traveling.

According to the battery apparatus 200 and the vehicle 600 of the present embodiment, the battery module BT is discharged while the vehicle 600 is traveling (power-running). In this state, while the temperature of the secondary battery 100 is equal to or higher than the threshold value, the battery module BT is cooled by the cooler 210. Further, in a case where the secondary battery 100 is brought into the state of the endothermic amount Qdis>the exothermic amount Qjex, the temperature of the secondary battery 100 gradually decreases.

Thereafter, in a case where the temperature of the secondary battery 100 becomes lower than the threshold value, the cooling of the battery module BT by the cooler 210 is stopped, and the battery module BT is charged with the regenerative current, so that the secondary battery 100 generates heat and is warmed, and the temperature of the secondary battery 100 rises.

During traveling of the vehicle 600, the discharging and cooling of the secondary battery 100 and the charging and warming thereof are repeatedly performed, and the temperature of the secondary battery 100 is substantially maintained near the threshold value.

The battery module BT is rapidly charged while the vehicle 600 is stopped, and the temperature of the secondary battery 100 temporarily increases. However, upon start of traveling of the vehicle 600, the temperature of the secondary battery 100 converges to the threshold value again.

As described above, according to the battery apparatus 200 and the vehicle 600 of the present embodiment, it is possible to avoid a decrease in performance of the secondary battery 100 due to a decrease in temperature. That is, according to the present embodiment, it is possible to provide a battery apparatus and a vehicle that exhibit stable performance.

The program according to the present embodiment may be transferred in a state of being stored in electronic equipment, or may be transferred in a state of not being stored in electronic equipment. In the latter case, the program may be transferred via a network or may be transferred in a state of being stored in a storage medium. The storage medium is a non-transitory tangible medium. The storage medium is a computer-readable medium. The storage medium may be any medium that can store a program and can be read by a computer, such as a CD-ROM or a memory card, and its form is not limited.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A battery apparatus comprising:
a battery module that comprises a plurality of secondary batteries;
a temperature detector that detects a temperature of at least one of the secondary batteries;
a current detector that detects a charge/discharge current of the battery module;
a cooler that cools the battery module; and
a processor that
periodically acquires values of detected temperature and charge/discharge current;
compares a temperature value of the secondary battery with a threshold value; and
stops the cooler and outputs a signal requesting the charge current of the battery module to a host control apparatus in a case where the battery module is discharged and the temperature value of the secondary battery becomes less than the threshold value.

2. The battery apparatus according to claim 1, wherein the secondary battery is a lithium ion secondary battery in which an entropy change due to a total battery reaction during discharging is endothermic in a range of 30% or more of a total depth of discharge.

3. The battery apparatus according to claim 1, wherein the secondary battery comprises an electrode active material having a depth of discharge region where a relationship between an endothermic amount Qdis during discharging and an exothermic amount Qjex due to an internal resistance of the secondary battery satisfies Qdis>Qjex.

4. The battery apparatus according to claim 1, wherein the secondary battery is a lithium ion secondary battery that generates heat accompanying a change in crystal structure of an active material due to insertion/extraction of lithium ions during charging.

5. The battery apparatus according to claim 1, wherein the secondary battery is a lithium ion secondary battery that comprises a negative electrode comprising a niobium-containing composite oxide, in which a basic skeleton of a crystal structure of the niobium-containing composite oxide is a Wadsley-Roth phase.

6. The battery apparatus according to claim 1, wherein in a case where the battery module is charged with the charge current supplied by the control of the host control apparatus and the temperature value of the secondary battery becomes equal to or more than the threshold value, the processor cools the battery module by the cooler and outputs a signal for requesting stop of the charge current of the battery module to the host control apparatus.

7. A method for controlling a battery apparatus comprising a cooler that cools a battery module comprising a plurality of secondary batteries,
the method comprising:
acquiring at least one temperature value of the secondary batteries and a charge/discharge current value of the battery module;
comparing the temperature value of the secondary battery with a threshold value; and
stopping the cooler and outputting a signal requesting the charge current of the battery module to a host control apparatus in a case where the battery module is discharged and the temperature value of the secondary battery becomes less than the threshold value.

8. A vehicle comprising:
the battery apparatus according to claim 1;
a motor that drives an axle by a rotational power and converts the power of the axle into AC power and outputs the AC power; and
a power conversion apparatus that converts DC power supplied from the battery apparatus into AC power and outputs the AC power to the motor, and converts the AC power supplied from the motor into DC power and outputs the DC power to the battery apparatus,
wherein the vehicle transmits an output command to the power conversion apparatus to output a regenerative current in a case of receiving a request for the charge current from the battery apparatus, and charges the battery module of the battery apparatus with the regenerative current.

9. The vehicle according to claim 8, wherein the secondary battery is a lithium ion secondary battery in which an entropy change due to a total battery reaction during discharging is endothermic in a range of 30% or more of a total depth of discharge.

10. The vehicle according to claim 8, wherein the secondary battery comprises an electrode active material having a depth of discharge region where a relationship between an endothermic amount Qdis during discharging and an exothermic amount Qjex due to an internal resistance of the secondary battery satisfies Qdis>Qjex.

11. The vehicle according to claim 8, wherein the secondary battery is a lithium ion secondary battery that generates heat accompanying a change in crystal structure of an active material due to insertion/extraction of lithium ions during charging.

12. The vehicle according to claim 8, wherein the secondary battery is a lithium ion secondary battery that comprises a negative electrode comprising a niobium-containing composite oxide, in which a basic skeleton of a crystal structure of the niobium-containing composite oxide is a Wadsley-Roth phase.

13. The vehicle according to claim 8, wherein in a case where the battery module is charged with the charge current supplied by the control of the host control apparatus and the temperature value of the secondary battery becomes equal to or more than the threshold value, the processor cools the battery module by the cooler and outputs a signal for requesting stop of the charge current of the battery module to the host control apparatus.
